(19) United States
(12) Patent Application Publication
(10) Pub. No.: US 2015/0371339 A1
(43) Pub. Date: Dec. 24, 2015

(54) E-MAILED RECEIPT GRAB AND STORAGE FOR CONSUMER TRACKING OF EXPENDITURES

(71) Applicant: MASTERCARD INTERNATIONAL INCORPORATED, Purchase, NY (US)

(72) Inventors: Jeremy Pastore, Purchase, NY (US); Michael Zhao, Purchase, NY (US)

(21) Appl. No.: 14/308,244

(22) Filed: Jun. 18, 2014

(51) Int. Cl. G06Q 40/00; G06F 17/30

(52) U.S. Cl. CPC G06Q 40/12; G06F 17/30253

(57) ABSTRACT

A computer-implemented method and system for recording a consumer's historical expenditures includes accessing incoming email associated with a consumer, identifying a receipt in the incoming email that was emailed from a merchant to the consumer in response to completing a cashless transaction associated with a payment network, linking the receipt to a transaction record generated by an acquirer within the payment network based on an indicator that the receipt and the transaction record were generated in response to the cashless transaction, and embedding the receipt with data from the transaction record associated with the payment network.

### FIELD OF THE DISCLOSURE

The present disclosure relates to a system and method for generating a consumer accessible database of details of the consumer's historical expenditures and, particularly, to capturing and storing data from sales receipts emailed from merchants to consumers.

### BACKGROUND

More and more merchants are e-mailing sales receipts to consumers in the regular course of business or at least offering consumers the option of receiving paperless receipts via email. Not only is this practice providing a convenient service to the customer, but it also reduces the merchant's printing costs.

### SUMMARY

Features of the disclosure will become apparent from the following detailed description considered in conjunction with the accompanying drawings. It is to be understood, however, that the drawings are designed as an illustration only and not as a definition of the limits of this disclosure.

The present disclosure is directed to a system and method for generating a consumer accessible database of details of the consumer's historical expenditures by accessing and storing sales receipts emailed from merchants to consumers and embedding records generated from those receipts with additional information and details retrieved from a merchant lookup table and, in various preferred embodiments, from transaction data associated with a payment network.

The present disclosure is directed to a method of recording a consumer's historical expenditures. The method includes accessing, using a processing device, incoming email associated with a consumer; and identifying, using the processing device, a receipt in the incoming email that was emailed from a merchant to the consumer in response to completing a cashless transaction associated with a payment network. The method further includes linking, using the processing device, the receipt to a transaction record generated by an acquirer within the payment network based on an indicator that the receipt and the transaction record were generated in response to the cashless transaction; and embedding, using the processing device, the receipt with data from the transaction record associated with the payment network.

In one aspect, the method further includes generating, using the processing device, a statement comprising the embedded receipt for access and viewing by the consumer.

In another aspect, wherein the receipt identified in the incoming email is in the form of an image, the method further includes saving, using the processing device, the image on a storage device; applying, using the processing device, object code recognition to digitize the image; extracting, using the processing device, textual content from the image to generate the receipt for embedding with the data from the transaction record; and linking, using the processing device, the image to the receipt.

In still another aspect, the identifying step is based on one or more indicators identifying the receipt from the incoming mail that was mailed from the merchant, the one or more indicators including the indicator that the receipt and the transaction record were generated in response to the cashless transaction.

In still another aspect, the receipt and the transaction record each include a timestamp, wherein the timestamp is the indicator that the receipt and the transaction record were generated in response to the cashless transaction, and the method includes linking the receipt to the transaction record based on the timestamp on the receipt being within a predetermined time of the timestamp on the transaction record.

In a further aspect, the indicator includes one of a predetermined indicator listed in a subject header of the incoming email, a merchant name, a merchant address, a merchant ID, a merchant code, an associated location, a “dba” name, a distribution email address, a telephone number, and an industry classification.

In yet another aspect, the receipt and the transaction record each include a timestamp, and the method includes linking the receipt to the transaction record based on the indicator and on the timestamp on the receipt being within a predetermined time of the timestamp on the transaction record.

The present disclosure is also directed to a system to record details of a consumer's historical expenditures. The system preferably includes a processing device; and memory to store instructions that, when executed by the processing device, cause the processing device to perform operations. The operations preferably include: accessing incoming email associated with a consumer; identifying a receipt in the incoming email that was emailed from a merchant to the consumer in response to completing a cashless transaction associated with a payment network; linking the receipt to a transaction record generated by an acquirer within the payment network based on an indicator that the receipt and the transaction record were generated in response to the cashless transaction; and embedding the receipt with data from the transaction record associated with the payment network.

In one aspect, the operations further include generating a statement comprising the embedded receipt for access and viewing by the consumer.

In another aspect, the receipt identified in the incoming email is in the form of an image, the operations further including saving the image on a storage device; applying object code recognition to digitize the image; extracting textual content from the image to generate the receipt for embedding with the data from the transaction record; and linking the image to the receipt.

In still another aspect, the operation of identifying the receipt is based on one or more indicators identifying the receipt from the incoming email that was mailed from the merchant.

In a further aspect, the receipt and the transaction record each include a timestamp, wherein the timestamp is the indicator that the receipt and the transaction record were generated in response to the cashless transaction, the operations including linking the receipt to the transaction record based on the timestamp on the receipt being within a predetermined time of the timestamp on the transaction record.

In yet another aspect, the indicator includes one of a predetermined indicator listed in a subject header of the incoming email, a merchant name, a merchant address, a merchant ID, a merchant code, an associated location, a “dba” name, a distribution email address, a telephone number, and an industry classification.

The present disclosure is also directed to a non-transitory computer-readable storage medium storing instructions that, when executed by a processing device, cause the processing device to record a consumer's historical expenditures by performing a computer process including the operations: accessing incoming email associated with a consumer; identifying a receipt in the incoming email that was emailed from a merchant to the consumer in response to completing a cashless transaction associated with a payment network; linking the receipt to a transaction record generated by an acquirer within the payment network based on an indicator that the receipt and the transaction record were generated in response to the cashless transaction; and embedding the receipt with data from the transaction record associated with the payment network.

In one aspect, the non-transitory computer-readable storage medium stores instructions that, when executed by the processing device, cause the processing device to record the consumer's historical expenditures by performing the computer process including the operations that further include generating a statement comprising the embedded receipt for access and viewing by the consumer.

In still a further aspect, the receipt is identified in the incoming email in the form of an image, the instructions stored on the non-transitory computer-readable storage medium, when executed by the processing device perform the operations further including: saving the image on a storage device; applying object code recognition to digitize the image; extracting textual content from the image to generate the receipt for embedding with the data from the transaction record; and linking the image to the receipt.

In yet another aspect of the non-transitory computer-readable storage medium, the operation of identifying the receipt is based on one or more indicators identifying the receipt from the incoming email that was mailed from the merchant.

In still another aspect of the non-transitory computer-readable storage medium, the receipt and the transaction record each include a timestamp, wherein the timestamp is the indicator that the receipt and the transaction record were generated in response to the cashless transaction, the operation including linking the receipt to the transaction record based on the timestamp on the receipt being within a predetermined time of the timestamp on the transaction record.

The present disclosure is also directed to a method of recording a consumer's historical expenditures including: accessing, using a processing device, incoming email associated with a consumer; identifying, using the processing device, a receipt in the incoming email that was emailed from a merchant to the consumer in response to completing a cashless transaction associated with a payment network; providing, using a server device, a merchant look-up table comprising records of a plurality of known merchants, each record comprising additional details for each of the plurality of known merchants, wherein the merchant look-up table is associated with the payment network; linking, using the processing device, the receipt to one of the records from the merchant look-up table based on an indicator that the corresponding known merchant associated with the linked record corresponds to the merchant that emailed the receipt; and embedding, using the processing device, the receipt with additional details associated with the corresponding known merchant from the merchant look-up table.

In one aspect, the consumer completes the cashless transaction using a payment card associated with the payment network, and the method further preferably includes generating, using a processing device, a payment card statement corresponding to a plurality of cashless transactions by the consumer using the payment card, wherein the payment card statement includes the receipt embedded with the additional details associated with the corresponding known merchant from the merchant look-up table.

In addition to the above aspects of the present disclosure, additional aspects, objects, features and advantages will be apparent from the embodiments presented in the following description and in connection with the accompanying drawings.

### BRIEF DESCRIPTION OF THE DRAWINGS

FIG. 1 is a schematic illustration of a representative cycle of transaction processing by a payment network of an electronic cashless sale.

FIG. 2 is a flow diagram representation of an embodiment of a method for generating a consumer accessible database of details of the consumer's historical expenditures in accordance with the present disclosure.

FIG. 3 is a flow diagram representation of another embodiment of a method for generating a consumer accessible database of details of the consumer's historical expenditures in accordance with the present disclosure.

FIG. 4 is a flow diagram representation of another embodiment of a method for generating a consumer accessible database of details of the consumer's historical expenditures in accordance with the present disclosure.

FIG. 5 is a schematic representation of an embodiment of a system for implementing various embodiments of the methods of the present disclosure.

### DESCRIPTION

The following sections describe particular embodiments. It should be apparent to those skilled in the art that the described embodiments provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present method and system as defined herein and equivalents thereto.

Throughout the description, where items are described as having, including, or comprising one or more specific components, or where methods are described as having, including, or comprising one or more specific steps, it is contemplated that, additionally, there are items of the present disclosure that consist essentially of, or consist of, the one or more recited components, and that there are methods according to the present disclosure that consist essentially of, or consist of, the one or more recited processing steps.

It should also be understood that the order of steps or order for performing certain actions is immaterial, as long as the method remains operable. Moreover, two or more steps or actions may be conducted simultaneously.

A “digital wallet” is known in the art and can be used by a consumer associated with the digital wallet for making an electronic transaction. Generally, the digital wallet has a data or information component associated with the consumer and transaction data, including payment methods, shipping addresses, billing address and other information. The information component is associated with a consumer interface for the consumer accessing the digital wallet to input necessary information for the transaction. The digital wallet is also associated with a software or services component for authorizing and completing the electronic transaction, including security and encryption for the customer's personal information and for the actual electronic transaction. Digital wallets can be used for remote, on-line, and point-of-sale purchases, and can be offered as a mobile app, particularly, a mobile phone app.

An “app” is used herein as that term is known, to refer to an application for a mobile device. An app, or mobile app, is a software application designed to run on, for example, smartphones, tablet computers, and other mobile devices.

A “cashless transaction” includes, but is not limited to, credit cards, debit cards, and other payment cards, and digital wallets in various platforms including remote on-line platforms, in point-of-sale transactions (for example, using NFC-enabled smart phones), and in other mobile devices.

The term “payment network” generally refers to a payment network for handling cashless transactions and is sometimes associated with a single payment card issuer, such as a credit card issuer. However, the term “payment network” as used herein can encompass both single card issuer networks and a network, such as a network of wallets that includes multiple card issuers. Accordingly, in various embodiments, the method and system of the present disclosure can provide details of a consumer's historical expenditures or spend data from merchant-generated email receipts for cashless transactions associated with one or more payment cards as well as for cash transactions.

The various services and applications for providing the methods of the present disclosure are preferably executable programs stored on a server device and are executed by a processing device associated with the server device. Such server devices hosting the associated services and applications may be maintained and operated by a payment network operator, or by a third-party hosting operator. The flow of various embodiments of the method of the present disclosure for generating a consumer accessible database of details of the consumer's historical expenditures is preferably directed by the hosted executable program code running on the server device or on any appropriate device known in the art for providing the embodiments of the methods of the present disclosure.

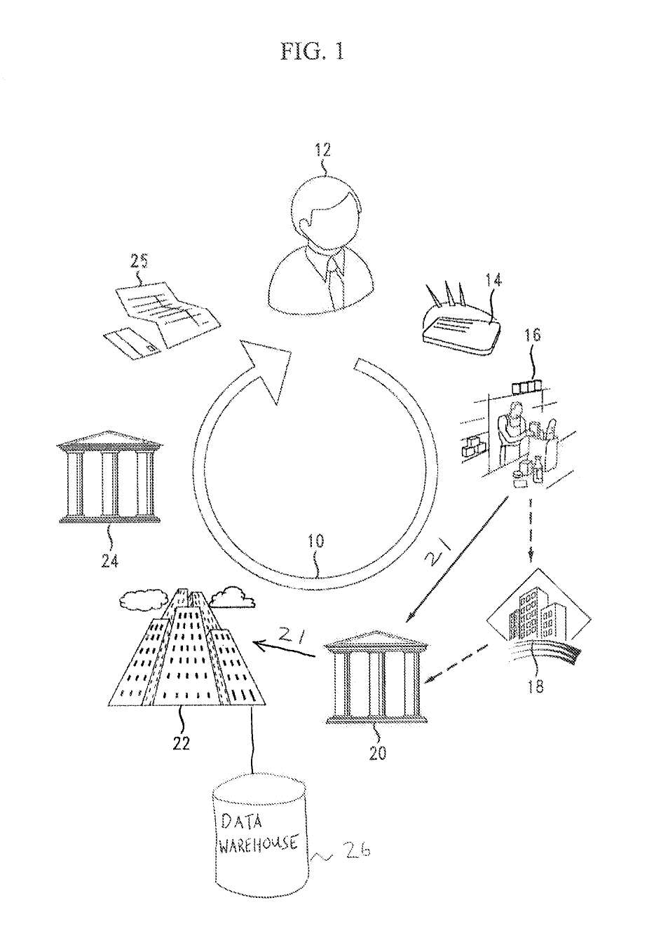

Referring to FIG. 1, in one embodiment of a typical cashless transaction a device holder 12 presents a payment instrument 14 to a merchant 16 for payment. Though the payment instrument is shown as a payment card, it can also be a transponder device, NFC-enabled smart phone, or any digital wallet selected for remote or on-line payment or provided as a mobile device app. In cases where the merchant 16 has an established merchant account with an acquiring bank (also called the acquirer) 20, the merchant communicates with the acquirer to secure payment on the transaction by sending a transaction request 21. An acquirer 20 is a party or entity, typically a bank, which is authorized by the network operator 22 to acquire network transactions on behalf of customers of the acquirer 20 (e.g., merchant 16). The merchant 16 may alternatively secure payment on a transaction through a third-party payment provider 18 authorized by the acquirer 20 and the network operator 22 to acquire payments on network transactions on behalf of the merchants. In this way, the merchant 16 can be authorized and able to accept the payment device 14 from a device holder 12, without having a merchant account with the acquirer 20.

The acquirer 20 typically populates and routes the transaction request 21 from the merchant to a network operating system (also referred to as “network operator”) 22 controlled by the network operations entity (for example, assignee MasterCard International Incorporated). The data included in the transaction request identifies the source of funds, or type of payment, used for the transaction. With this information, the network operator 22 routes the transaction to an issuer 24, typically a bank, which is authorized by the network operator 22 to issue payment devices 14 on behalf of its customers (e.g., device holder 12), for use in payment transactions within the payment network. The issuer 24 also typically funds the transaction that it approves. The issuer 24 may approve or authorize the transaction request based on criteria such as a device holder's credit limit, account balance, or in certain instances more detailed and particularized criteria including transaction amount, merchant classification and so on.

The issuer 24 decision to authorize or decline the transaction is routed through the network operator 22 and acquirer 20, and ultimately to the merchant 16 at the point of sale. This entire process is carried out by electronic communication, and under routine circumstances (i.e., valid device, adequate funds, etc.) can be completed in a matter of seconds. It permits the merchant 16 to engage in transactions with a device holder 12, and the device holder 12 to partake of the benefits of cashless electronic payment, while the merchant 16 can be assured that payment is secured.

The transaction request from the merchant, which includes details of the payment transaction for authorization, is generally further populated by the acquirer 20 with merchant information and then forwarded to the issuer. A central database, or data warehouse 26, is also associated with and maintained by the payment network for storing and augmenting this payment transaction data on a regular basis for use in marketing, macroeconomic reporting, and so on.

Each payment card transaction record that is stored in the data warehouse 26 is associated with a consumer, and includes at least a date and time of the transaction, an account number and/or other identifying data of the cardholder making the purchase, a merchant ID and/or merchant name, and, generally, other merchant location and/or identification information of the merchant associated with the transaction, along with the financial details of the purchase.

The payment network operator also maintains a lookup table or database of merchants with associated details, which may include one or more details such as the merchant ID, merchant name, merchant address, associated location(s), “dba” names, distribution email address(es), telephone number(s), merchant code, industry classification and/other identifying information, and regularly updates and verifies the merchant data stored in the database associated with the payment network in accordance with various methods known in the art. This information is used to augment and enrich the payment transaction data stored in the data warehouse 26 with additional details of the merchant associated with each transaction.

Upon a consumer's completion of a cashless transaction, a merchant typically emails a receipt to the consumer. For many web-based or on-line purchases, the email receipt is automatically sent upon completion of the transaction. For other types of transactions, for example, at point-of-sale, the consumer may be asked if an email receipt is desired for cash transactions, as well as for cashless transactions. In addition, many consumers now use digital wallets via their mobile devices through which in-app sales receipts may be generated and stored.

In one embodiment of the present disclosure, a method for generating a consumer accessible database of details of the consumer's historical expenditures includes accessing and storing sales receipts emailed from merchants to consumers and embedding records generated from those receipts with additional information and details retrieved from a merchant lookup table provided, for example, by a payment network operator. The historical spend data that is enriched with details from the merchant lookup table may be associated with a single payment network operator or card issuer that maintains the merchant lookup table.

Consumer access to the card holder's own historical spend data may be provided, for example, via a website hosted by the payment card operator. The historical spend data may be offered in the form of a card statement, and may be made available through a payment history service offered through the customer's payment card account management page, for example.

Consumers can participate in the service and access their historical spend data preferably after an opt-in registration process, which requires each user to grant permission to access his/her email account(s) and to provide the necessary identifying information for accessing the email account(s).

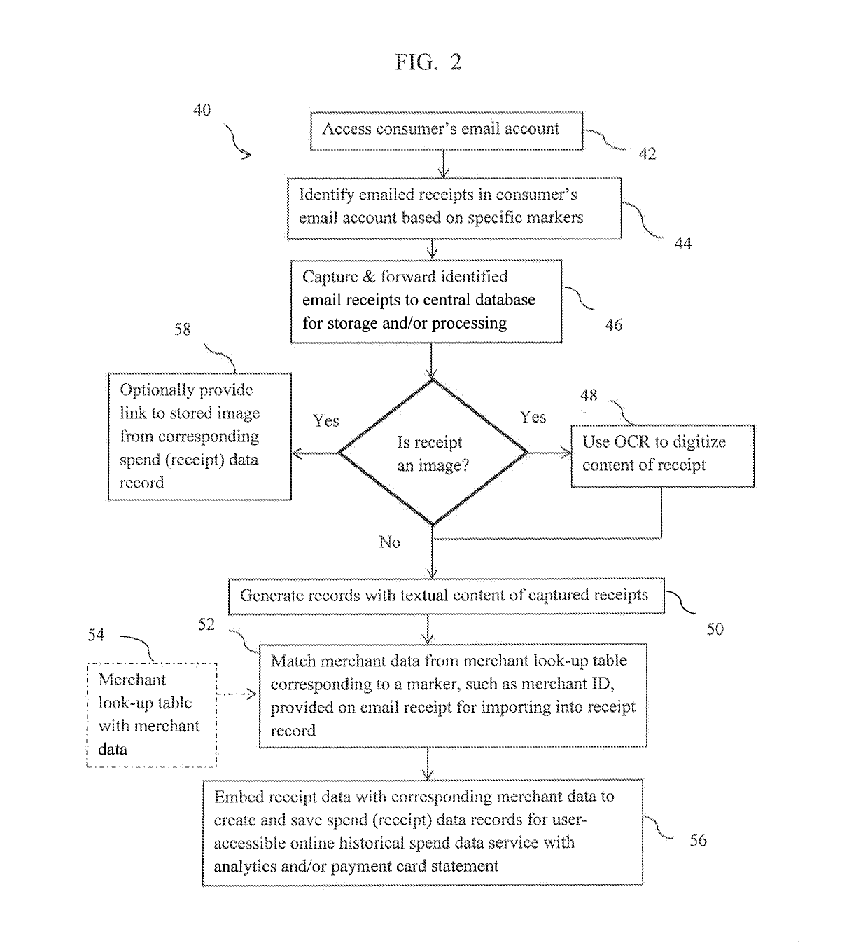

Referring to FIG. 2, one embodiment 40 of a method in accordance with the present disclosure includes accessing a consumer's email account 42 after the consumer has opted in to the service, and identifying email receipts in the consumer's email account based on specific markers or criteria 44. The consumer's email account may be based on and accessed through any known email client, for example, such as Microsoft Outlook, IBM Lotus Notes, Pegasus Mail, Mozilla's Thunderbird, Eudora, KMail, Evolution, or any other email client installed on the consumer's computer, or through a web-based email client such as Gmail, Lycos Mail, Mail.com, Outlook.com and Yahoo! Mail. In other embodiments, the consumer's received emails may also be retrieved from a mobile device associated with the consumer on which emails are stored.

Still referring to FIG. 2, the consumer's email account may be searched in step 44 to identify emailed receipts generated and/or forwarded by known merchants based on various markers or indicators that the email came from a merchant. For example, words such as “RECEIPT” in the header can identify a merchant emailed sales receipt generated either at a point of sale or from an online transaction. In a particular embodiment, merchants can opt to insert a predetermined marker in the subject header or body of the text for easy identification of such receipts.

In additional embodiments, indicators can also include known email addresses of merchants that are preferably stored in a merchant lookup table 54 associated with the service. The email addresses of the consumer's incoming emails are scanned to identify email addresses that match the known email addresses of merchants in the merchant lookup table 54. Other indicators that can be used to identify emailed receipts from merchants are also preferably stored in the merchant lookup table and include the merchant's name, address, associated location(s), telephone number(s), “dba” names, a merchant ID, merchant code, industry classification, and so on. Accordingly, the body and subject headers of the consumer's emails are preferably also scanned to identify matches to any of the other indicators in the merchant lookup table 54. Various methods in the art may be employed to perform string matching for identifying email receipts generated by merchants based on these and other markers or indicators.

In particular embodiments, the method for generating a consumer accessible database of details of the consumer's historical expenditures also includes identifying sales receipt data generated from in-app wallet purchases from, for example, the consumer's mobile device.

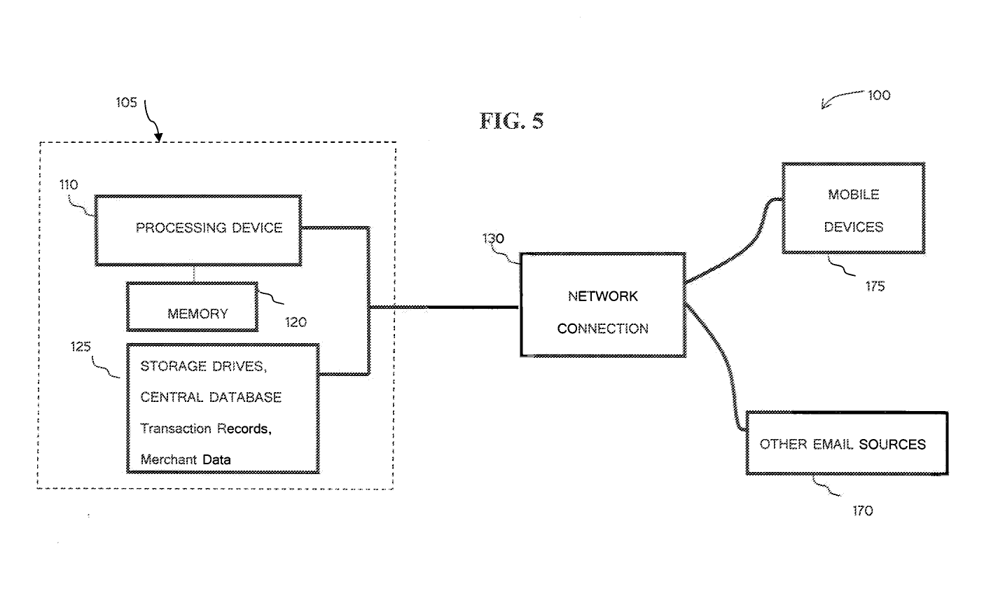

Referring to FIG. 2 as well as to FIG. 5, in step 46, copies of the identified emailed receipts and, optionally, in-app wallet receipts, are preferably retrieved, or captured, from devices, such as mobile devices 175 or from other email sources 170. The receipts then are forwarded by a server device 105 to a central database, for example, on a storage device 125 associated with the service. In one embodiment, the server device 105 is a payment card network's server.

Records of the textual content of the identified emailed receipts are preferably generated from the captured receipts 50 for embedding with additional data from, for example, merchant look-up tables 54.

The merchant look-up tables 54 may be stored with the central database 125 or can be stored on a separate storage device and/or in a separate database.

In various embodiments, receipts can be retrieved and stored as images. If the receipt is retrieved or captured in image format, optical code recognition (OCR) can be used to digitize and extract the textual contents of the receipt 48 to generate a textual receipt record 50. The captured receipt image is optionally stored at step 58 for retrieval and viewing via a hyperlink, for example, associated with the record of the receipt. Accordingly, when a consumer pulls up his or her online credit card statement, for example, formed in accordance with the present disclosure, the consumer can click on any record of a transaction and get an image of the actual receipt, if available.

Any of the markers or indicators described supra can be used to match the merchant that generated the sales receipt with the corresponding merchant data stored in the merchant lookup table. Referring to FIG. 2, in one embodiment, the method further includes matching merchant data from the merchant lookup table that corresponds to a merchant ID (or other indicator) on an emailed receipt 52 for importing into the receipt record. Accordingly, at step 56 any missing or incorrect merchant data can then be embedded into a receipt record generated from the merchant generated receipt. The enhanced receipt records, which can be associated via a hyperlink to an image of the actual emailed or in-app receipt, are preferably made available to the consumer associated with the receipt via a website or and app and provide easily understandable historical timelines of the consumer's expenditures.

Additional features can be provided to the consumer to analyze the expenditures, such as analytical graphs showing the consumer his/her purchases by category, including detailed spending graphs by category or merchant over time, “opt-in” targeted advertisements based on spending patterns and location, budgeting metrics, and budgeting alerts. For example, the service could include automatically sending alerts to a predefined distribution email(s) when a cardholder's spending in a product category meets or exceeds a desired threshold based on the historical spending records acquired from the merchants' emailed receipts and further enhanced by data from merchant look-up records and, in particular embodiments, from transaction records.

In particular embodiments, on-line payment card management and tracking services available to consumers can include receipt data associated with the consumer's use of the particular payment card that is generated in accordance with any of the methods of the present disclosure.

The importation of additional merchant data from the merchant lookup tables provides several advantages. Often, merchant-emailed receipts only list an identifier such as a merchant ID number for the merchant, or a corporation name or other third-party name associated with processing the merchant's transactions, and do not list the actual store-front name where the purchase was made. This leads to confusion and concern when the consumer later reviews his or her payment history and does not recognize the vendor. The enrichment of the receipt data with merchant data from a lookup table, which is preferably provided by a payment network that regularly updates and verifies such data, provides a history of expenditures listing easily recognizable merchant names and locations.

In additional embodiments of the present disclosure, for cashless transactions, additional transaction level detail from the corresponding payment network is preferably imported into captured emailed receipts. While there are on-line credit card account services that allow a consumer to review usage, such services may provide at the most a breakdown of expenditures by the types of stores (using the merchant codes) frequented. In preferred embodiments of the present disclosure, by making such transaction level data available to consumers, additional information can be made available, including the amount of money the consumer is spending by product, and by line item, for each receipt.

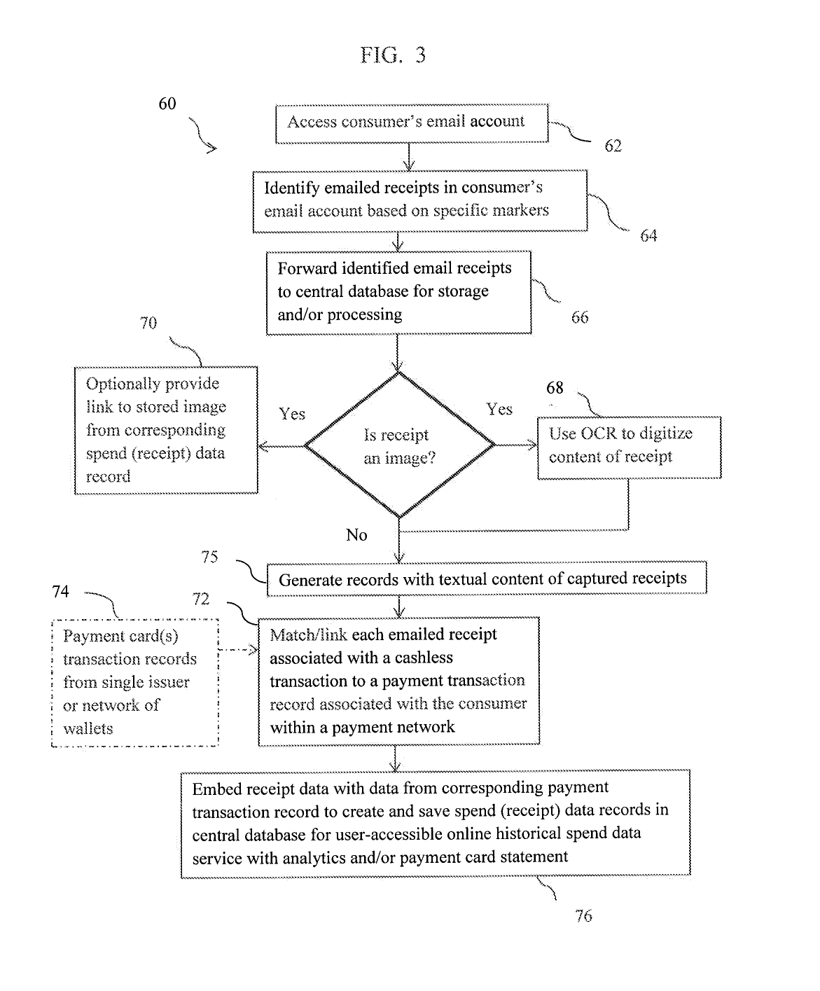

Referring to FIG. 3, for example, upon accessing a consumer's email account 62, if a transaction is completed with a payment card, at step 72, the emailed and, optionally, in-app generated receipt data is matched or linked with a corresponding payment card transaction record 74 associated with the consumer. The method includes identifying each emailed receipt 64 and also linking each emailed receipt to a payment transaction record associated with the consumer based on one or more specific markers or indicators 72. Such markers or indicators can include the same indicators described supra that the email came from a merchant: that is, predetermined key words or markers in the header or body of the email, known email addresses of merchants or other known data that are preferably stored in a merchant lookup table associated with the service, including the merchant's name, address, associated location(s), “dba” names, distribution email address(es), telephone number(s), a merchant ID, merchant code, industry classification, and so on.

Because a record of every cashless payment transaction 74 associated with the consumer is stored in the data warehouse 26 with a timestamp (calendar date and time) that is contemporaneous with the consumer's purchase, in one embodiment, the consumer's emailed receipt is preferably linked to the corresponding payment transaction record 72 by matching a timestamp on the email with a contemporaneous timestamp recorded with a payment transaction record associated with the consumer. For example, a payment transaction record 74 is linked with a receipt if the timestamp on the receipt indicates that the receipt was generated within a predetermined time of the timestamp on the payment transaction record, and, optionally, if another indicator identifies the transaction and the receipt as originating from the same merchant. In various embodiments, steps 64 and 72 can be performed simultaneously in one step, and the identifying indicators may include the same indicator used to link the captured email receipt to the corresponding transaction record 74.

Copies of the emailed receipts identified at 64 and, optionally, in-app wallet receipts, are preferably retrieved, or captured, from the servers and/or other devices 102 storing the receipts and are forwarded at 66 by a server device 105 to a central database stored on a storage device 125 associated with the service. Preferably, the server device 105 is a payment card network's server. The central database 66 may be the data warehouse 26 associated with the payment card network, or a third party database that is accessible to the server 105.

In various embodiments, receipts can be retrieved and stored as images. In one embodiment, if the receipt is retrieved in image format, optical code recognition (OCR) can be used to digitize and extract the textual contents of the receipt 68 and generate a textual receipt record. The receipt image file is optionally stored at 70 for retrieval and viewing via a hyperlink, for example, associated with the record of the receipt.

Records of the textual content of the identified emailed receipts are preferably generated from the captured receipts at 75 for embedding with the additional data from the payment transaction records 74. At 76, the textual email receipt data is preferably embedded with the matched or linked transaction record data to generate a single receipt record containing the combined data that was matched at 72. The enhanced receipt records, which can be associated via a hyperlink to an image of the actual emailed or in-app receipt, are preferably made available to the consumer associated with the receipt via a website or an app, and provide easily understandable historical timelines of the consumer's expenditures. Additional features can be provided to the consumer to analyze the expenditures, such as analytical graphs showing the consumer his/her purchases by category, including detailed spending graphs by category or merchant over time, “opt-in” targeted advertisements based on spending patterns and location, budgeting metrics, and budgeting alerts. For example, the service could include automatically sending alerts to a predefined distribution email(s) when a cardholder's spending in a product category meets or exceeds a desired threshold based on the historical spending records acquired from the merchants' emailed receipts and transaction records.

As described in reference to FIG. 1, the payment transaction records of cashless transactions stored by a payment network are updated and augmented with merchant data from the merchant lookup table maintained by the payment network operator. Consequently, in the embodiment of FIG. 3, in addition to the transaction-level payment data, additional merchant data from the merchant lookup tables is preferably also merged into the receipt data, providing the same advantages as the embodiment described in reference to FIG. 2, such as importing the actual store-front name where the purchase was made into the receipt records. In addition, the added details extracted from the merchant receipts and matched with actual payment card purchases offer payment card companies the ability to offer consumers enhanced spending analytics at the SKU level using the information extracted from the merchant's receipts for each of their payment card purchases.

In various embodiments, methods for generating a consumer accessible database of details of a consumer's expenditures within a payment network are implemented using a mobile wallet system and wallet app that track cashless transactions and utilizes a mobile device or computer's email client to automatically lookup an emailed receipt and link the receipt to a payment transaction contemporaneously with, or after, a purchase is made. In one embodiment, the wallet would not create its own electronic receipt, but would rely on the merchant to generating the receipt and email it to the consumer. The wallet application would then look up the receipt in the email client based on any of the indicators or markers described herein, such as transaction time, merchant name or ID, and/or a known email address for the merchant.

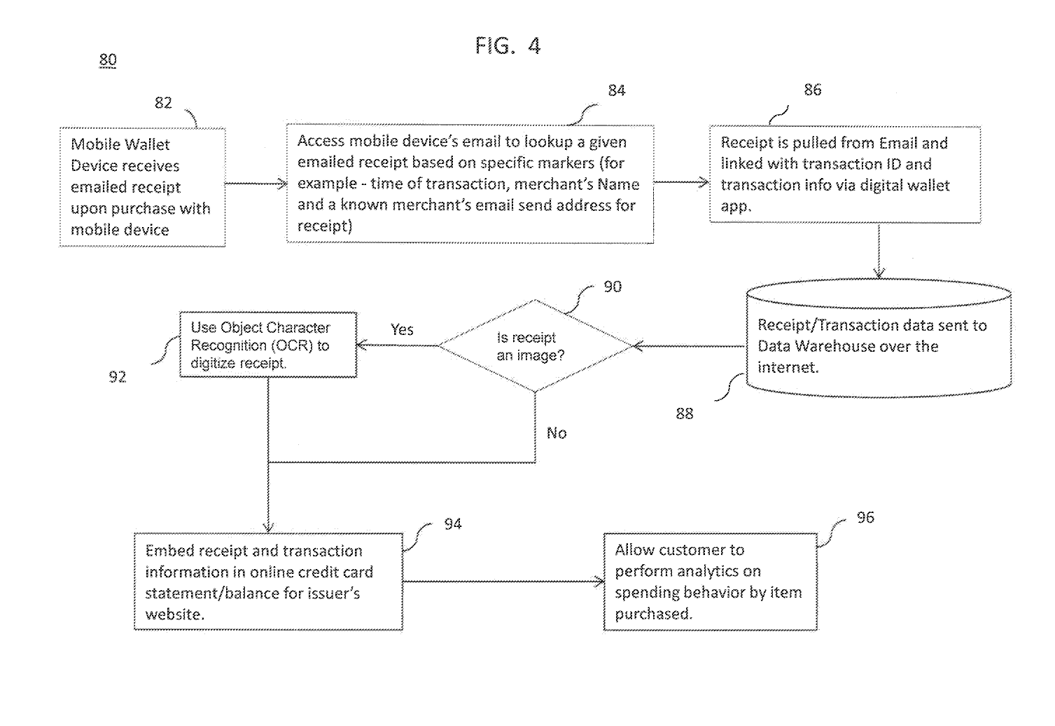

Referring to FIG. 4, for example, in one embodiment 80, a mobile wallet device receives an emailed receipt from a merchant 82 after the consumer has made a purchase via the mobile wallet application. The mobile device's email is accessed and the emailed receipt is identified based on specific markers or indicators 84 either contemporaneously with, or after the wallet purchase. A copy of the receipt is then extracted from the email and linked with a corresponding payment transaction record 86 via the wallet app and both the payment transaction record and emailed receipt are preferably sent to the data warehouse 88 associated with the payment network.

If the receipt is an image 90, OCR can be implemented to digitize the textual content of the receipt 92. The receipt data is embedded with the transaction record details 94 and the resultant enhanced receipt record is preferably saved in a database associated with the payment network for generating online credit card statements and analytics 96 accessible to the consumer.

The embodiments of the present disclosure can be offered as a service by an issuer of the payment network that stores the transaction record data, or via a third-party website.

The embodiments of the present disclosure can also be adapted by an operator of a network of wallets, such as that described in co-owned U.S. patent application Ser. No. 13/746,904, filed Jan. 22, 2013, entitled “System and Method to Enable a Network of Digital Wallets.” Accordingly, transaction records from a plurality of wallets and payment cards associated with a consumer can be made available for linking with emailed and/or in-app receipts in accordance with the embodiments of the disclosure. Moreover, spending analytics can be generated across multiple card issuers. In addition, details of purchases made with each payment card within the network of wallets can be stored and made available to the consumer. Access to payment card history formed from the detailed receipt records merged with transaction data in accordance with the present disclosure can then be provided, for example, by any of the card issuers associated with the payment network via a customer's card account management page, for example, or by the operator of a network of wallets as a separate service.

### Embodiment of a System for Implementing the Methods of the Present Disclosure

Referring to FIG. 5, the various embodiments of the methods of the present disclosure are implemented via computer software or executable instructions or code. FIG. 5 is a schematic representation of an embodiment of a system 100 for implementing the methods of the present disclosure. The system includes at least a server device 105 including a processing device 110 or a Central Processing Unit (CPU), memory or computer readable storage 120, and may also include storage drives 125 and/or may be operably connected to storage drive(s) 125. In one embodiment the server device 105 is associated with a payment network and a central database is maintained on one of the storage drives 125 associated with the payment network. The central database, or data warehouse 26, preferably stores the merchant lookup tables as well as the payment transaction records generated by consumers' purchases within the payment network.

The system 100 also preferably includes a network connection 130 for connecting to consumers' mobile devices 175 as a source of consumers' emails, or to other email sources 170, such as, but not limited to, the Internet, which may also receive emails in response to digital wallet purchases.

The memory or computer readable storage 120 is accessible by the CPU and stores instructions that when executed by the CPU 110 causes the processor 110 to implement the steps of the methods described herein. The memory or computer readable storage 120 can include, but is not limited to, random access memory (RAM), read only memory (ROM), a storage device including a hard drive, or a portable, removable computer readable medium, such as a compact disk (CD) or a flash memory, or a combination thereof. The computer executable instructions for implementing the methods of the present invention may be stored in any one type of memory associated with the system 100, or distributed among various types of memory devices provided, and the necessary portions loaded into RAM, for example, upon execution.

In one embodiment, a non-transitory computer readable product is provided, which includes a computer readable medium storing computer executable instructions or program code for performing the method steps described herein and that can be accessed by the processing device.

It should be recognized that the components illustrated in FIG. 5 are exemplary only, and that it is contemplated that the methods described herein may be implemented by various combinations of hardware, software, firmware, circuitry, and/or processors and associated memory, for example, as well as other components known to those of ordinary skill in the art.

While the methods and system of the present disclosure have been particularly shown and described with reference to specific embodiments, it should be apparent to those skilled in the art that the foregoing is illustrative only and not limiting, having been presented by way of example only. Various changes in form and detail may be made therein without departing from the spirit and scope of the disclosure. Therefore, numerous other embodiments are contemplated as falling within the scope of the present methods and system as defined by the accompanying claims and equivalents thereto.

What is claimed is:

1. A method of recording a consumer's historical expenditures, the method comprising:
accessing, using a processing device, incoming email associated with a consumer;
identifying, using the processing device, a receipt in the incoming email that was emailed from a merchant to the consumer in response to completing a cashless transaction associated with a payment network;
linking, using the processing device, the receipt to a transaction record generated by an acquirer within the payment network based on an indicator that the receipt and the transaction record were generated in response to the cashless transaction; and
embedding, using the processing device, the receipt with data from the transaction record associated with the payment network.

2. The method of claim 1, further comprising generating, using the processing device, a statement comprising the embedded receipt for access and viewing by the consumer.

3. The method of claim 1, wherein the receipt identified in the incoming mail is in the form of an image, the method further comprising:
saving, using the processing device, the image on a storage device;
applying, using the processing device, object code recognition to digitize the image;
extracting, using the processing device, textual content from the image to generate the receipt for embedding with the data from the transaction record; and
linking, using the processing device, the image to the receipt.

4. The method of claim 1, wherein the identifying step is based on one or more indicators identifying the receipt from the incoming mail that was mailed from the merchant, the one or more indicators including the indicator that the receipt and the transaction record were generated in response to the cashless transaction.

5. The method of claim 1, wherein the receipt and the transaction record each include a timestamp, wherein the timestamp is the indicator that the receipt and the transaction record were generated in response to the cashless transaction, the method including linking the receipt to the transaction record based on the timestamp on the receipt being within a predetermined time of the timestamp on the transaction record.

6. The method of claim 1, wherein the indicator includes one of a predetermined indicator listed in a subject header of the incoming email, a merchant name, a merchant address, a merchant ID, a merchant code, an associated location, a dba name, a distribution email address, a telephone number, and an industry classification.

7. The method of claim 6, wherein the receipt and the transaction record each include a timestamp, the method including linking the receipt to the transaction record based on the indicator and on the timestamp on the receipt being within a predetermined time of the timestamp on the transaction record.

8. A system to record details of a consumer's historical expenditures, the system comprising:
a processing device; and
memory to store instructions that, when executed by the processing device, cause the processing device to perform operations comprising:
accessing incoming email associated with a consumer;
identifying a receipt in the incoming email that was emailed from a merchant to the consumer in response to completing a cashless transaction associated with a payment network;
linking the receipt to a transaction record generated by an acquirer within the payment network based on an indicator that the receipt and the transaction record were generated in response to the cashless transaction; and
embedding the receipt with data from the transaction record associated with the payment network.

9. The system of claim 8, the operations further comprising generating a statement comprising the embedded receipt for access and viewing by the consumer.

10. The system of claim 8, wherein the receipt identified in the incoming mail is in the form of an image, the operations further comprising:
saving the image on a storage device;
applying object code recognition to digitize the image;
extracting textual content from the image to generate the receipt for embedding with the data from the transaction record; and
linking the image to the receipt.

11. The system of claim 8, wherein the identifying the receipt is based on one or more indicators identifying the receipt from the incoming mail that was mailed from the merchant.

12. The system of claim 8, wherein the receipt and the transaction record each include a timestamp, wherein the timestamp is the indicator that the receipt and the transaction record were generated in response to the cashless transaction, the operations further including linking the receipt to the transaction record based on the timestamp on the receipt being within a predetermined time of the timestamp on the transaction record.

13. The system of claim 8, wherein the indicator includes one of a predetermined indicator listed in a subject header of the incoming email, a merchant name, a merchant address, a merchant ID, a merchant code, an associated location, a dba name, a distribution email address, a telephone number, and an industry classification.

14. A non-transitory computer-readable storage medium storing instructions that, when executed by a processing device, cause the processing device to record a consumer's historical expenditures by performing a computer process comprising the operations:
accessing incoming email associated with a consumer;
identifying a receipt in the incoming email that was emailed from a merchant to the consumer in response to completing a cashless transaction associated with a payment network;
linking the receipt to a transaction record generated by an acquirer within the payment network based on an indicator that the receipt and the transaction record were generated in response to the cashless transaction; and
embedding the receipt with data from the transaction record associated with the payment network.

15. The non-transitory computer-readable storage medium of claim 14, further storing instructions that, when executed by the processing device, cause the processing device to perform operations further comprising generating a statement comprising the embedded receipt for access and viewing by the consumer.

16. The non-transitory computer-readable storage medium of claim 14, wherein the receipt identified in the incoming mail is in the form of an image, the non-transitory computer-readable storage medium storing further instructions that, when executed by the processing device, cause the processing device to perform operations further comprising:
saving the image on a storage device;
applying object code recognition to digitize the image;
extracting textual content from the image to generate the receipt for embedding with the data from the transaction record; and
linking the image to the receipt.

17. The non-transitory computer-readable storage medium of claim 14, wherein the identifying the receipt is based on one or more indicators identifying the receipt from the incoming mail that was mailed from the merchant.

18. The non-transitory computer-readable storage medium of claim 14, wherein the receipt and the transaction record each include a timestamp, wherein the timestamp is the indicator that the receipt and the transaction record were generated in response to the cashless transaction, the non-transitory computer-readable storage medium further storing instructions that, when executed by the processing device, cause the processing device to perform operations further comprising linking the receipt to the transaction record based on the timestamp on the receipt being within a predetermined time of the timestamp on the transaction record.

19. A method of recording a consumer's historical expenditures, the method comprising:
accessing, using a processing device, incoming email associated with a consumer;
identifying, using the processing device, a receipt in the incoming email that was emailed from a merchant to the consumer in response to completing a cashless transaction associated with a payment network;
providing, using a server device, a merchant look-up table comprising records of a plurality of known merchants, each record comprising additional details for each of the plurality of known merchants, wherein the merchant look-up table is associated with the payment network;
linking, using the processing device, the receipt to one of the records from the merchant look-up table based on an indicator that the corresponding known merchant associated with the linked record corresponds to the merchant that mailed the receipt; and
embedding, using the processing device, the receipt with additional details associated with the corresponding known merchant from the merchant look-up table.

20. The method of claim 19, wherein the consumer completes the cashless transaction using a payment card associated with the payment network, further comprising generating, using a processing device, a payment card statement corresponding to a plurality of cashless transactions by the consumer using the payment card, wherein the payment card statement includes the receipt embedded with the additional details associated with the corresponding known merchant from the merchant look-up table.
